(19) United States
(12) Patent Application Publication
(10) Pub. No.: US 2025/0130741 A1
(43) Pub. Date: Apr. 24, 2025

(54) IMAGE READING DEVICE

(71) Applicant: SHARP KABUSHIKI KAISHA, Sakai City (JP)

(72) Inventors: RISA SUZUKI, Sakai City (JP); TAKASHI YAMANAKA, Sakai City (JP); KOHJI KATAMOTO, Sakai City (JP); KATSUTOSHI ISHIKAWA, Sakai City (JP); MIHO YAMAMURA, Sakai City (JP); SHIZUKA BUN, Sakai City (JP); MEGUMI IDO, Sakai City (JP); MASAO SAEDA, Sakai City (JP)

(21) Appl. No.: 18/919,876

(22) Filed: Oct. 18, 2024

(30) Foreign Application Priority Data
Oct. 20, 2023 (JP) 2023-180656

(51) Int. Cl. G06F 3/12; H04N 1/00

(52) U.S. Cl. CPC G06F 3/1205; G06F 3/1253; H04N 1/00411

(57) ABSTRACT

An image reading device comprises a controller, wherein in a case where an operation of instructing maintenance of a state in which a setting content of at least one setting item is set as a manually changed setting content is performed on an operation acceptor, the controller maintains the state in which the setting content of at least the one setting item is set as the manually changed setting content, and automatically sets setting contents of remaining setting items other than the setting content of at least the one setting item, included in the setting contents of the plurality of setting items.

### CROSS-REFERENCE TO RELATED APPLICATION

The present application claims priority from Japanese Application JP2023-180656, the content of which is hereby incorporated by reference into this application.

### BACKGROUND

### 1. Field

The present disclosure relates to an image reading device.

### 2. Description of the Background Art

The image forming device has an APS function for detecting the size of a document, an ADS function for detecting the density of the document, and an ACS function for detecting the color of the document. In this image forming device, an initial screen of an operation acceptor displays density setting display for setting the density of an image to be printed, color setting display for setting the color of the image, size setting display for setting the size of paper on which the image is formed, and automatic mode display for activating all of the APS, ACS, and ADS functions. In a case where the automatic mode display is pressed, a main controller performs control to erase the density setting display, the color setting display, and the size setting display from a display screen of the operation acceptor (summary).

### SUMMARY

For example, in a case where the automatic mode display is pressed after, for example, some of setting contents of the density, the color, and the paper size are manually changed from default setting contents, the manually changed setting contents are ignored, and, for example, all of the setting contents of the density, the color, and the paper size are automatically set. Therefore, it is not possible to easily perform semi-automatic setting for manually changing the setting content of some setting items from the default setting content and automatically setting the setting contents of the remaining setting items.

An aspect of the present disclosure has been made in light of this problem. According to an aspect of the present disclosure, an object thereof is to provide an image reading device that can easily perform semi-automatic setting for manually changing a setting content of at least one setting item from a default setting content and automatically setting setting contents of remaining setting items, for example.

An image reading device according to an aspect of the present disclosure includes: an image reader that reads an image in accordance with setting contents of a plurality of setting items; an operation acceptor; a display; and a controller, wherein in a case where first operation of manually changing a setting content of at least one setting item included in the setting contents of the plurality of setting items is performed on the operation acceptor, the controller sets the setting content of at least the one setting item as a manually changed setting content, in a case where third operation for an operation target, for which second operation of instructing automatic setting of the setting contents of the plurality of setting items is to be performed after the setting of the setting content of at least the one setting item as the manually changed setting content, is performed on the operation acceptor, the controller causes the display to display a screen for asking whether or not a state in which the setting content of at least the one setting item is set as the manually changed setting content is maintained, and in a case where fourth operation of instructing maintenance of the state in which the setting content of at least the one setting item is set as the manually changed setting content is performed on the operation acceptor, the controller maintains the state in which the setting content of at least the one setting item is set as the manually changed setting content, and automatically sets setting contents of remaining setting items other than the setting content of at least the one setting item, included in the setting contents of the plurality of setting items.

### BRIEF DESCRIPTION OF THE DRAWINGS

FIG. 1 is a block diagram of a multifunction peripheral (MPF) of a first embodiment.

FIG. 2 is a diagram illustrating operation performed on an operation acceptor provided in the MPF of the first embodiment and setting contents of a plurality of setting items that an image reader provided in the MPF follows.

FIG. 3A is a table illustrating an example of setting content options of a plurality of setting items that the image reader provided in the MPF of the first embodiment follows.

FIG. 3B is a table illustrating an example of default setting contents of a plurality of setting items that the image reader provided in the MPF of the first embodiment follows.

FIG. 3C is a table illustrating an example of a setting content for an automatic setting of a plurality of setting items that the image reader provided in the MPF of the first embodiment follows.

FIG. 4 is a diagram illustrating an example of transition of a screen which the controller causes a touch panel display provided in the MPF to display in a case where the controller provided in the MPF of the first embodiment causes an image reader provided in the MPF to read an image.

FIG. 5 is a diagram illustrating an example of transition of a screen which the controller causes the touch panel display provided in the MPF to display in a case where the controller provided in the MPF of the first embodiment causes the image reader provided in the MPF to read the image.

FIG. 6 is a diagram illustrating an example of transition of a screen which the controller causes the touch panel display provided in the MPF to display in a case where the controller provided in the MPF of the first embodiment causes the image reader provided in the MPF to read the image.

FIG. 7 is a diagram illustrating an example of transition of a screen which the controller causes the touch panel display provided in the MPF to display in a case where the controller provided in the MPF of the first embodiment causes the image reader provided in the MPF to read the image.

FIG. 8 is a diagram illustrating an example of transition of a screen which the controller causes the touch panel display provided in the MPF to display in a case where the controller provided in the MPF of the first embodiment causes the image reader provided in the MPF to read the image.

FIG. 9 is a diagram illustrating an example of transition of a screen which the controller causes the touch panel display provided in the MPF to display in a case where the controller provided in the MPF of the first embodiment causes the image reader provided in the MPF to read the image.

FIG. 10 is a flowchart illustrating an example of a flow of processes performed by the controller in a case where the controller provided in the MPF of the first embodiment causes the image reader provided in the MPF to read the image.

FIG. 11 is a flowchart illustrating an example of a flow of processes performed by the controller in a case where the controller provided in the MPF of the first embodiment causes the image reader provided in the MPF to read the image.

FIG. 12 is a flowchart illustrating an example of a flow of processes performed by the controller in a case where the controller provided in the MPF of the first embodiment causes the image reader provided in the MPF to read the image.

FIG. 13 is a flowchart illustrating an example of a flow of processes performed by the controller in a case where the controller provided in the MPF of the first embodiment causes the image reader provided in the MPF to read the image.

FIG. 14 is a flowchart illustrating an example of a flow of processes performed by the controller in a case where the controller provided in the MPF of the first embodiment causes the image reader provided in the MPF to read the image after a manually changed setting content is stored.

FIG. 15 is a diagram illustrating an example of transition of a screen which a controller causes a touch panel display provided in an MPF to display in a case where the controller provided in the MPF of a second embodiment registers a manual setting item in a semi-auto mode.

FIG. 16 is a diagram illustrating an example of transition of a screen which the controller causes the touch panel display provided in the MPF to display in a case where the controller provided in the MPF of the second embodiment registers a manual setting item in a semi-auto mode.

FIG. 17 is a flowchart illustrating an example of a flow of processes performed by a controller in a case where the controller provided in the MPF of the second embodiment registers a manual setting item in a semi-auto mode.

FIG. 18 is a diagram illustrating an example of transition of a screen which the controller causes the touch panel display provided in the MPF to display in a case where the controller provided in the MPF of the second embodiment additionally registers a manual setting item in a semi-auto mode.

FIG. 19 is a diagram illustrating an example of transition of a screen which the controller causes the touch panel display provided in the MPF to display in a case where the controller provided in the MPF of the second embodiment additionally registers a manual setting item in a semi-auto mode.

FIG. 20 is a diagram illustrating an example of transition of a screen which the controller causes the touch panel display provided in the MPF to display in a case where the controller provided in the MPF of the second embodiment additionally registers a manual setting item in a semi-auto mode.

FIG. 21 is a flowchart illustrating a flow of processes performed by the controller in a case where the controller provided in the MPF of the second embodiment additionally registers a manual setting item in a semi-auto mode.

FIG. 22 is a diagram illustrating a first example of transition of a screen which the controller causes the touch panel display provided in the MPF to display in a case where the controller provided in the MPF of the second embodiment changes a setting content of a manual setting item in a semi-auto mode.

FIG. 23 is a diagram illustrating a first example of transition of a screen which the controller causes the touch panel display provided in the MPF to display in a case where the controller provided in the MPF of the second embodiment changes a setting content of a manual setting item in a semi-auto mode.

FIG. 24 is a diagram illustrating a second example of transition of a screen which the controller causes the touch panel display provided in the MPF to display in a case where the controller provided in the MPF of the second embodiment changes a setting content of a manual setting item in a semi-auto mode.

FIG. 25 is a diagram illustrating a second example of transition of a screen which the controller causes the touch panel display provided in the MPF to display in a case where the controller provided in the MPF of the second embodiment changes a setting content of a manual setting item in a semi-auto mode.

FIG. 26 is a flowchart illustrating an example of a flow of processes performed by the controller in a case where the controller provided in the MPF of the second embodiment changes a setting content of a manual setting item in a semi-auto mode.

FIG. 27 is a flowchart illustrating an example of a flow of processes performed by the controller provided in the MPF in a case where a semi-auto button is pressed on the touch panel display provided in the MPF of the second embodiment.

### DESCRIPTION OF EMBODIMENTS

Embodiments of the present disclosure will be hereinafter described with reference to the drawings. In the drawings, the same or equivalent elements are given the same reference numerals, and overlapped description will be omitted.

### 1 First Embodiment

### 1.1 Multifunction Peripheral

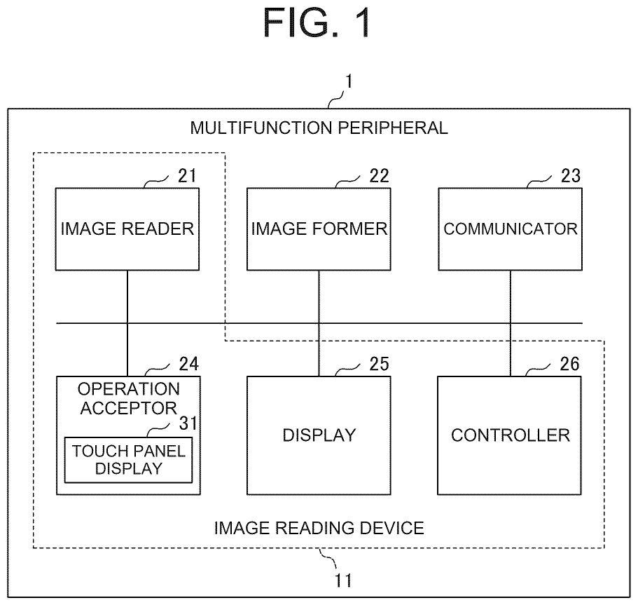

FIG. 1 is a block diagram of a multifunction peripheral (MPF) of a first embodiment.

An MPF 1 illustrated in FIG. 1 has a copy mode, a print mode, a fax mode and a scan mode. Therefore, the MPF 1 incorporates an image reading device 11 required for the copy mode, the fax mode, and the scan mode. The image reading device 11 may be incorporated in a dedicated copy machine, a dedicated fax machine, or a dedicated scanner machine.

The MPF 1 includes an image reader 21, an image former 22, a communicator 23, an operation acceptor 24, a display 25, and a controller 26. The image reader 21, the operation acceptor 24, the display 25, and the controller 26 constitutes the image reading device 11.

The image reader 21 reads an image on a document and generates image data according to the read image. The image reader 21 includes an automatic document feeder (ADF), a document reader, a document stand, and a reading device. In a case where the image reader 21 reads an image on a document by using an ADF method, the ADF sends each document included in a plurality of documents set in the ADF to the document reader, and the reading device reads the image on each document sent to the document reader. In a case where the image reader 21 reads an image on a document by using a flatbed method, a reading mechanism reads an image on a document set on the document stand.

The image former 22 forms an image according to the image data on paper. The image former 22 forms an image on paper by, for example, electrophotography, inkjet printing, or thermal printing.

The communicator 23 is connected to a public switched telephone network and a network. The communicator 23 transmits a fax signal corresponding to the image data to a fax machine connected to the public switched telephone network. The communicator 23 receives the fax signal corresponding to the image data from the fax machine connected to the public switched telephone network, and acquires the image data from the received fax signal. The communicator 23 transmits the image data to a device connected to the network. The communicator 23 receives the image data from the device connected to the network.

The operation acceptor 24 accepts operation.

As illustrated in FIG. 1, the operation acceptor 24 includes a touch panel display 31. The touch panel display also serves as the display 25. The operation acceptor 24 may include an operation member other than the touch panel display 31. For example, the operation acceptor 24 may include a button, a lever, a dial, a slider, and the like.

The display 25 displays a screen. The display 25 includes, for example, a liquid crystal display, an organic light emitting diode (OLED) display, a quantum dot light emitting diode (QLED) display, and the like.

The controller 26 controls the image reader 21, the image former 22, the communicator 23, the operation acceptor 24, and the display 25.

The controller 26 includes a processor, a memory, a storage, and peripheral circuits. The storage stores programs. The processor executes the programs loaded from the storage to the memory and causes the processor, the memory, the storage and the peripheral circuits to activate as the controller 26. Some or all of processes performed by the processor may be performed by dedicated electronic circuits.

In a case where the MPF 1 is in the copy mode, the controller 26 causes the image reader 21 to read an image on a document and generate image data according to the read image. The controller 26 also causes the image former 22 to form an image according to the generated image data on paper.

In a case where the mode of the MPF 1 is the print mode, the controller 26 causes the communicator 23 to receive the image data. The controller 26 also causes the image former 22 to form an image according to the received image data.

In a case where the mode of the MPF 1 is the fax mode and fax transmission is performed, the controller 26 causes the image reader 21 to read the image on the document and generate image data according to the image read. In addition, the controller 26 causes the communicator 23 to transmit a fax signal corresponding to the generated image data to a fax machine connected to the public switched telephone network.

In a case where the mode of the MPF 1 is the fax mode and fax reception is performed, the controller 26 causes the communicator 23 to receive the fax signal corresponding to the image data from the fax machine connected to the public switched telephone network and to acquire the image data from the received signal. The controller 26 also causes the image former 22 to form an image according to the acquired image data on paper.

In a case where the mode of the MPF 1 is the scan mode, the controller 26 causes the image reader 21 to read the image on the document and generate image data according to the image read. The controller 26 causes the communicator 23 to transmit the generated image data to the device connected to the network.

### 1.2 Setting Content

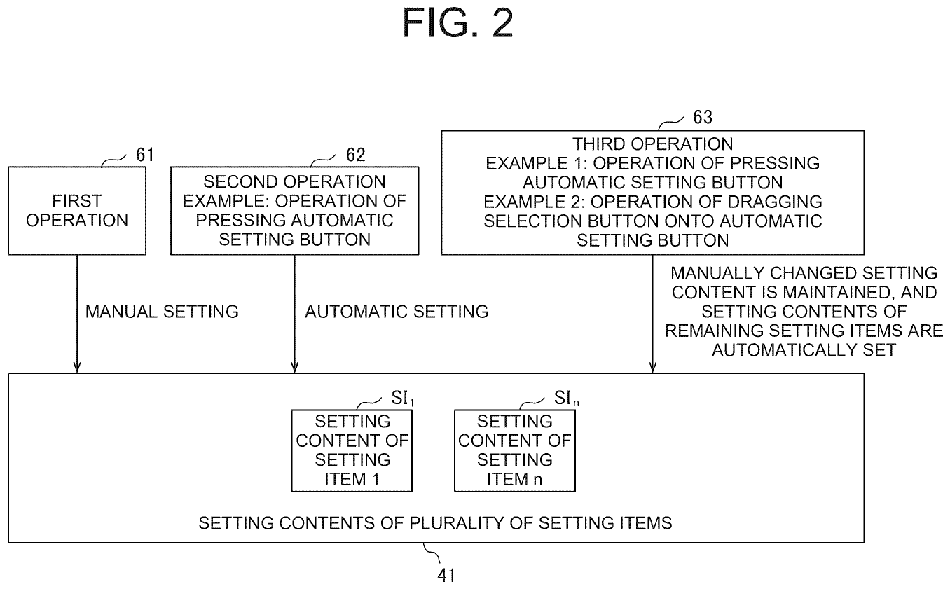

FIG. 2 is a diagram illustrating operation performed by the operation acceptor provided in the MPF of the first embodiment and setting contents of a plurality of setting items that the image reader provided in the MPF follows.

The image reader 21 reads the image according to the setting contents 41 of the plurality of setting items illustrated in FIG. 2. The setting contents 41 of the plurality of setting items are composed of a setting content SI₁ of a setting item 1, . . . , and a setting content SIₙ of a setting item n.

In the operation acceptor 24, first operation 61, second operation 62, and third operation 63 illustrated in FIG. 2 are performed. The first operation 61 is operation of manually changing a setting content of at least one setting item included in the setting contents 41 of the plurality of setting items from a default setting content to a manually changed setting content. The manually changed setting content is variable. The second operation 62 is operation of instructing automatic setting of the setting contents 41 of the plurality of setting items, such as pressing of an automatic setting button. The third operation 63 is operation performed on an operation target for which the second operation 62 is to be performed, such as operation of pressing the automatic setting button or dragging, onto the automatic setting button, a selection button for selecting a setting item. The third operation 63 may be the same as the second operation 62, or may be different operation from the second operation 62. In the first embodiment, a form in which the third operation 63 is the same operation as the second operation 62 will be described. In the second embodiment, a form in which the third operation 63 is different operation from the second operation 62 will described.

The setting content of each setting item included in the setting contents 41 of the plurality of setting items can be manually changed from the default setting content to the manually changed setting content by the first operation 61 on the operation acceptor 24 performed by a user, and the user can automatically set the setting content of each setting item on the MPF 1 by performing the second operation 62 on the operation acceptor 24. The setting content of each setting item can be set to the default setting content, when the user does not perform any of the first operation 61, the second operation 62, and the third operation 63 to the operation acceptor 24.

The plurality of setting items include “document,” “resolution,” and “blank page skipping.” Therefore, the setting contents 41 of the plurality of setting items include setting contents of the “document,” the “resolution” and the “blank page skipping”

The setting content of the “document” may include the size of the document, the orientation of the document, whether to read an image on both sides or only one side of the document, and the orientation of the image on the document. The setting content of the “document” may include other items in addition to those listed above.

The setting content of the “resolution” includes the resolution in the main scanning direction and the resolution in the sub scanning direction. The setting content of the “resolution” may include items other than those listed above.

The setting content of the “blank page skipping” includes whether to skip a blank document and read an image on a document other than the blank document. The setting content of the “blank page skipping” may include items other than those listed above.

The plurality of setting items may include setting items other than the “document,” the “resolution” and the “blank page skipping”. Therefore, the setting contents 41 of the plurality of setting items may include a setting content of a setting item other than the “document,” the “resolution,” and the “blank page skipping.” For example, the plurality of setting items may include “black and white,” “document tilt correction,” “compression rate,” and the like. Therefore, the setting contents 41 of the plurality of setting items may include setting contents of the “black and white,” the “document tilt correction,” the “compression rate,” and the like.

The “black and white” setting content indicates whether the image on the document is read in black and white binary or grayscale.

The setting content of the “document tilt correction” indicates whether to correct the tilt of the document or the tilt of the image on the document.

The setting content of the “compression rate” indicates the compression rate of generated image data.

In a case where the second operation 62 is performed on the operation acceptor 24 without performing the first operation 61 on the operation acceptor 24, the controller 26 automatically sets the setting content SI₁ of the setting item 1, . . . , and the setting content SIₙ of the setting item n that constitutes the setting contents 41 of the plurality of setting items. Therefore, the image reader 21 reads the image in accordance with the setting content SI₁ of the setting item 1, . . . , and the setting content SIₙ of the setting item n that are automatically set.

In a case where the first operation 61 is performed on the operation acceptor 24, the controller 26 sets the setting content of at least one setting item included in the setting contents 41 of the plurality of setting items as a manually changed setting content. The manually changed setting content is a setting content that is different from the default setting content and corresponds to the performed first operation. The setting content of at least the one setting item may be the setting content of one setting item or may be the setting contents of two or more setting items. In a case where the third operation 63 is performed on the operation acceptor 24 after the setting content of the at least the one setting item is set as the manually changed setting content, the controller 26 does not automatically set the setting content of at least the one setting item, and maintains a state in which the setting content of at least the one setting item is set as the manually changed setting content. In a case where the third operation 63 is performed on the operation acceptor 24 after the setting content of at least the one setting item is set at the manually changed setting content, the controller 26 automatically sets the setting content of the remaining setting items other than the setting content of as the least one setting item, which are included in the setting contents 41 of the plurality of setting items. Consequently, it is possible to provide the image reading device 11 that can easily perform semi-automatic setting for manually setting the setting content of at least the one setting item and automatically setting the setting contents of the remaining setting items.

In a case where the controller 26 automatically sets the setting content SI₁ of the setting item 1, . . . , and the setting content SIₙ of the setting item n, the controller 26 sets the setting content SI₁ of the setting item 1, . . . , and the setting content SIₙ of the setting item n to the respective setting contents suitable for the document.

### 1. 3 Example of Default Setting Content and Automatically Set Setting Content

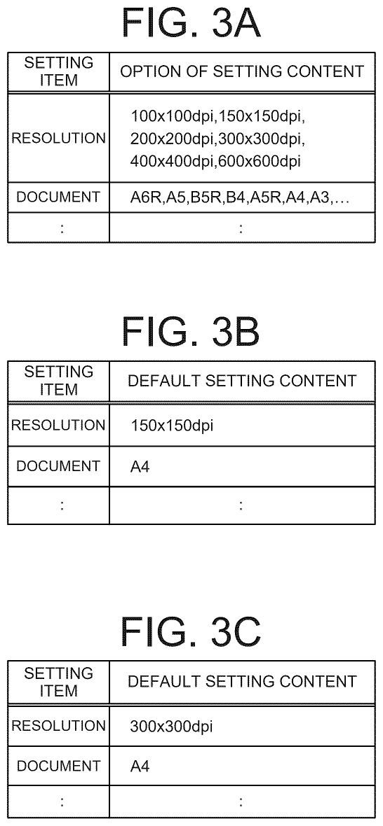

FIG. 3A is a table illustrating an example of setting content options of a plurality of setting items that the image reader provided in the MPF of the first embodiment follows. FIG. 3B is a table illustrating an example of a default setting content of a plurality of setting items that the image reader provided in the MPF of the first embodiment follows. FIG. 3C is a table illustrating an example of a setting content for an automatic setting of a plurality of setting items that the image reader provided in the MPF of the first embodiment follows.

The controller 26 stores a plurality of options of the setting content for each setting item included in the plurality of setting items. The controller 26 selects the setting content of each setting item from the plurality of setting content options stored for each setting item. For example, as illustrated in FIG. 3A, the controller 26 stores “100× 100 dpi,” “150× 150 dpi,” “200×200 dpi,” “300× 300 dpi,” “400× 400 dpi,” and “600×600 dpi” which are a plurality of setting content options for the “resolution.” The controller 26 selects the setting content for the “resolution” from the plurality of setting content options “100× 100 dpi,” “150× 150 dpi,” “200×200 dpi,” “300× 300 dpi,” “400× 400 dpi,” and “600×600 dpi.” Additionally, the controller 26 stores “A6R,” “A5,” “B5R,” “B4,” “A5R,” “A4,” “A3,” . . . , that are a plurality of setting content options for the “document.” The controller 26 selects the setting content for the “document” from the plurality of options of the setting content “A6R,” “A5,” “B5R,” “B4,” “A5R,” “A4,” “A3,” . . . .

The controller 26 stores the default setting content for each setting item included in the plurality of setting items. When the MPF 1 starts up, the controller 26 sets the setting content of each setting item as the default setting content stored for each setting item. The controller 26 maintains a state in which the setting content of each setting item is the default setting content, except a case where the first operation 61 in which the setting content of each setting item is manually changed from the default setting content is performed, or a case where the setting content of each setting item is automatically set. For example, as illustrated in FIG. 3B, the controller 26 stores the default setting content “150×150 dpi” for the “resolution.” When the MPF 1 starts up, the controller 26 sets the setting content of the “resolution” as the default setting content “150×150 dpi” stored for the “resolution.” The controller 26 maintains a state in which the setting content of the “resolution” is the default setting content of “150×150 dpi” except in a case where the first operation 61 in which the setting content of the “resolution” is manually changed from the default setting content “150×150 dpi” to a manually changed setting content such as “200× 200 dpi” that is different from the default setting content. In addition, the controller 26 stores the default setting content “A4” for the “document.” When the MPF 1 starts up, the controller 26 sets the setting content of the “document” as the default setting content “A4” stored for the “document.” The controller 26 maintains a state in which the setting content of the “document” is the default setting content “A4,” except a case where the first operation 61 in which the setting content of the “document” is manually changed from the default setting content “A4” to a manually changed setting content such as “A3” that is different from the default setting content is performed, or a case where the setting content of the “document” is automatically set.

The controller 26 stores setting content for automatic setting for each setting item included in the plurality of setting items. In a case where the controller 26 automatically sets the setting content of each setting item, the controller 26 forcibly changes the setting content of each setting item to the setting content for automatic setting stored for each setting item. The controller 26 stores the default setting content for each setting item, and also stores the setting contents for automatic setting. Therefore, the setting content for automatic setting stored for each setting item may be the same as the default setting content stored for each setting item, or may be different from the default setting content stored for each setting item. For example, as illustrated in FIG. 3C, the controller 26 stores a setting content for automatic setting “300× 300 dpi” for the “resolution.” In a case where the controller 26 automatically sets the setting content of the “resolution,” the controller 26 forcibly changes the setting content of the “resolution” to the setting content for automatic setting “300×300 dpi” stored for the “resolution.” In addition, the controller 26 stores the setting content for automatic setting “A4” for the “document.” In a case where the controller 26 automatically sets the setting content of the “document,” the controller 26 forcibly changes the setting content of the “document” to the setting content for automatic setting “A4” stored for the “document.” The setting content for automatic setting of the resolution or the like may be set on the basis of image data generated by reading the image on the document set on the document stand by the image reader 21.

1. 4 Transition of Screen in Case where Image Reader Reads Image

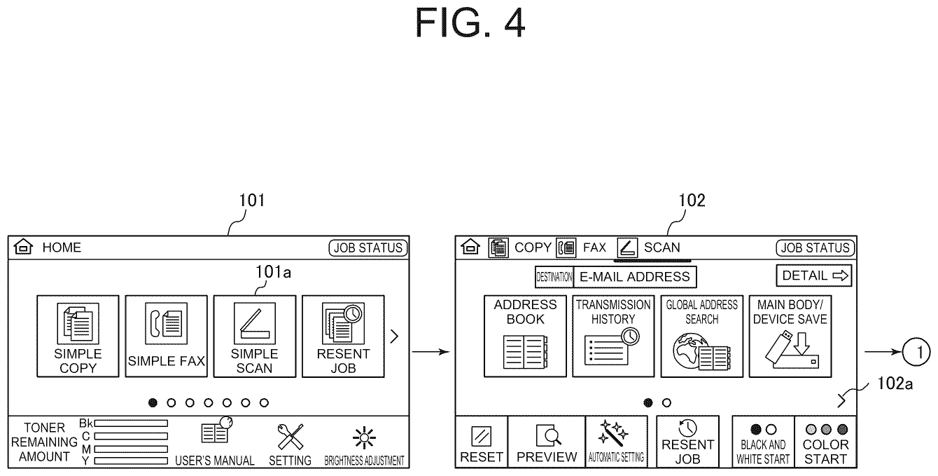

FIG. 4 to FIG. 9 are diagrams each illustrating an example of transition of a screen which the controller causes the touch panel display provided in the MPF to display in a case where the controller provided in the MPF of the first embodiment causes the image reader provided in the MPF to read an image.

In a case where the controller 26 causes the image reader to read an image, the controller 26 performs transition of a screen to be displayed on the touch panel display 31 as illustrated in FIG. 4 to FIG. 9.

The controller 26 causes the touch panel display 31 to display a home screen 101, as illustrated on the left side of FIG. 4. The home screen 101 is used to select a mode of the MPF 1. The home screen 101 has a simple scan button 101a.

In a case where operation of pressing the simple scan button 101a is performed on the touch panel display 31, the controller 26 terminates the display of the home screen 101 on the touch panel display 31, as illustrated on the right side of FIG. 4, and causes the touch panel display 31 to display a destination selection screen 102 in the scan mode. The destination selection screen 102 in the scan mode is used to select a destination to which image data is to be sent. The destination selection screen 102 in the scan mode has a switching button 102a.

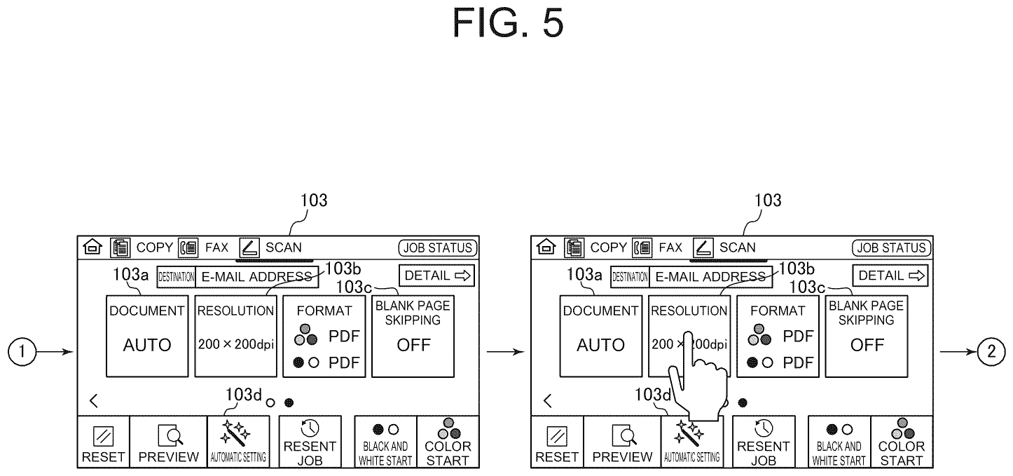

In a case where the switching button 102a is pressed on the touch panel display 31, the controller 26 terminates the display of the destination selection screen 102 in the scan mode, as illustrated on the left side of FIG. 5, and displays a setting screen 103 in the scan mode on the touch panel display 31. The setting screen 103 in the scan mode is used for operation of selecting the “document,” the “resolution” or the “blank page skipping,” and operation of instructing automatic setting of the setting contents of the “document,” the “resolution” and the “blank page skipping.” The setting screen 103 in the scan mode has a document button 103a, a resolution button 103b, a blank page skipping button 103c, and an automatic setting button 103d. At this point, the controller 26 sets the setting contents of the “document,” the “resolution,” and the “blank page skipping” as the default setting contents “Auto,” “200×200 dpi” and “Off,” respectively. Therefore, the controller 26 displays character strings “Automatic,” “200×200 dpi” and “Off” indicating the default setting contents “Automatic,” “200×200 dpi” and “Off” which are the setting contents of the “document,” the “resolution” and the “blank page skipping” at this time on the document button 103a, the resolution button 103b and the blank page skipping button 103c, respectively.

The document button 103a, the resolution button 103b, and the blank page skipping button 103c are examples of selection buttons that are used to select a setting item. The automatic setting button 103d is an example of an operation target for which operation of instructing automatic setting of the setting contents of the “document,” the “resolution” and the “blank page skipping” is to be performed. The operation of pressing the automatic setting button 103d is an example of the second operation 62 and the third operation 63.

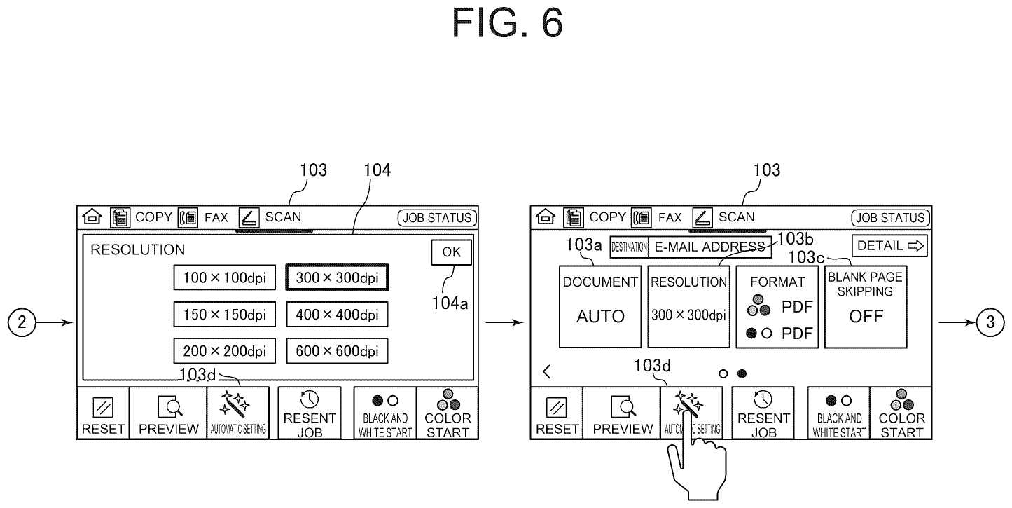

In a case where operation of pressing the document button 103a, the resolution button 103b, and the blank page skipping button 103c is performed on the touch panel display 31, the controller 26 causes the touch panel display 31 to display a document setting screen, a resolution setting screen, and a blank page skipping setting screen, which are superimposed on the setting screen 103 in a scan mode. The document setting screen, the resolution setting screen and the blank page skipping setting screen are setting screens used to manually set the setting contents of the “document,” the “resolution” and the “blank page skipping,” respectively. For example, in a case where operation of pressing the resolution button 103b is performed on the touch panel display 31 as illustrated on the right side of FIG. 5, the controller 26 causes the touch panel display 31 to display a resolution setting screen 104 superimposed on the setting screen 103 in the scan mode, as illustrated on the left side of FIG. 6. The resolution setting screen 104 has an OK button 104a.

In a case where operation of selecting the manually changed setting content “300× 300 dpi” is performed on the touch panel display 31, and then operation of pressing the OK button 104a is performed on the touch panel display 31, the controller 26 terminates displaying of the resolution setting screen 104 on the touch panel display 31, sets the setting content of the “resolution” to the manually changed setting content “300×300 dpi,” and updates the setting screen 103 in the scan mode, as illustrated on the right side of FIG. 6. At that time, the controller 26 causes the resolution button 103b to display the character strings “300×300 dpi” indicating the manually changed setting content “300×300 dpi.”

A series of operation consisting of pressing of the resolution button 103b, selecting of the manually changed setting content “300×300 dpi,” and pressing of the OK button 104a is an example of the first operation 61. The setting content of the “resolution” is an example of the setting content of at least the one setting item that is manually changed. The setting contents of the “document” and the “blank page skipping” are examples of setting contents of the remaining setting items other than the setting contents of at least the one setting item that is manually changed.

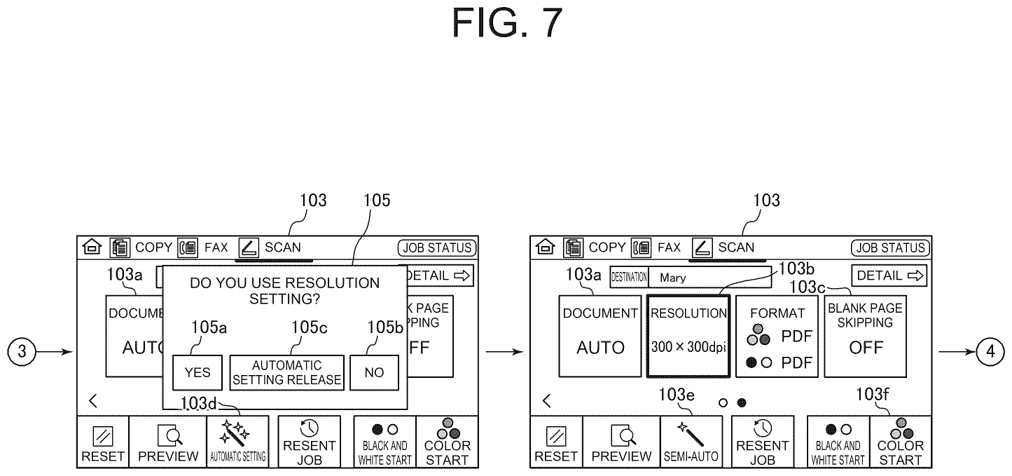

In a case where the automatic setting button 103d is pressed on the touch panel display 31, the controller 26 causes the touch panel display 31 to display a screen 105 superimposed on the setting screen 103 in the scan mode, as illustrated on the left side of FIG. 7. The screen 105 asks whether to maintain a state in which the setting content of the “resolution” is the manually changed setting content “300×300 dpi.” The screen 105 has a Yes button 105a, a No button 105b, and an automatic setting release button 105c.

When operation of pressing the Yes button 105a is performed on the touch panel display 31, the controller 26 maintains the state in which the setting content of the “resolution” is manually changed to the manually changed setting item “300×300 dpi,” and automatically sets the setting contents of the “document” and the “blank page skipping.” When the controller 26 automatically sets the setting contents of the “document” and the “blank page skipping,” the controller 26 sets the setting contents of the “document” and the “blank page skipping” to the setting content for the automatic setting “Automatic” and “Off,” respectively. The controller 26 also updates the setting screen 103 in the scan mode, as illustrated on the right side of FIG. 7. At that time, the controller 26 displays, on the document button 103a, the resolution button 103b, and the blank page skipping button 103c, the character strings “Automatic,” “300×300 dpi” and “Off” which indicate the setting content for the automatic setting “Automatic,” the manually changed setting content “300×300 dpi” and the setting content for the automatic setting “Off” which are the setting contents of the “document,” the “resolution” and the “blank page skipping” at this time, respectively. At that time, the controller 26 also displays a semi-auto button 103e on the setting screen 103 in the scan mode instead of the automatic setting button 103d. In addition, the controller 26 displays a scan start button 103f on the setting screen 103 in the scan mode. The semi-auto button 103e indicates that the state in which the setting contents of the “resolution” is the resolution of “300×300 dpi” is maintained, and that the setting contents of “document” and the “blank page skipping” are automatically set. That is, the semi-auto button 103e indicates that the setting contents of the “document,” the “resolution” and the “blank page skipping” are semi-automatically set. In addition, the controller 26 changes the display state of the resolution button 103b from a normal display state to a display state indicating that the state in which the setting content of the “resolution” is set to the manually changed setting content different from the default setting content is maintained. The change indicating that the state in which the setting content of the “resolution” is set from the normal display state to the manually changed setting content different from the default setting content is maintained is performed, for example, by changing brightness, color, shape, and the like. The controller 26 causes the touch panel display 31 to display a screen element which indicates that the setting contents of the “document,” the “resolution” and the “blank page skipping” are semi-automatically set, such as the semi-auto button 103e, so that the user can easily recognize that the setting contents of the “document,” the “resolution” and the “blank page skipping” are semi-automatically set. In addition, the controller 26 causes the touch panel display 31 to display a third operation target such as the semi-auto button 103e, which is different from a second operation target such as the automatic setting button 103d, so that the user can easily recognize that the setting contents of the “document,” the “resolution” and the “blank page skipping” are semi-automatically set.

In a case where the automatic setting button 103d is pressed and the state in which the setting content of the “resolution” is set to the manually changed setting content “300×300 dpi” is released, the setting contents of the “document,” the “resolution” and the “blank page skipping” cannot be set semi-automatically. It is conceivable that the setting content of the “resolution” is set to the manually changed setting content “300×300 dpi,” but this makes the operation more troublesome, in a case where an administrator of the MPF 1 use an administration screen to press the automatic setting button 103d. On the other hand, in a case where the automatic setting button 103d is pressed and the state in which the setting content of the “resolution” is the manually changed setting content “300×300 dpi” is maintained, the setting contents of the “document,” the “resolution” and the “blank page skipping” can be easily set semi-automatically.

Operation of pressing the Yes button 105a is an example of fourth operation of instructing to maintain the state in which the setting content of the “resolution” is the manually changed setting content “300×300 dpi.”

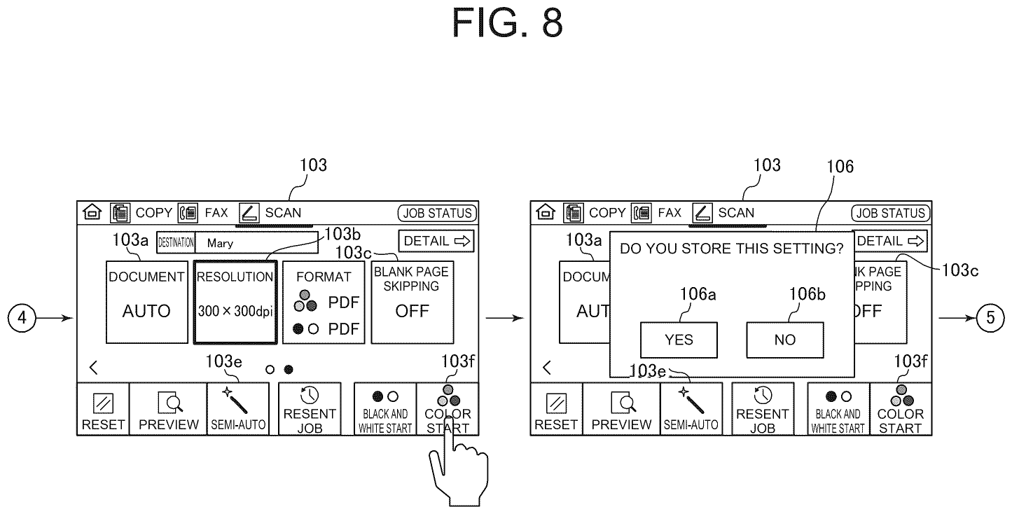

In a case where operation of pressing the scan start button 103f is performed on the touch panel display 31 as illustrated on the left side of FIG. 8, the controller 26 causes the touch panel display 31 to display a screen 106 on the setting screen 103 in the scan mode, as illustrated on the right side of FIG. 8. The screen 106 asks whether or not to store the manually changed setting content “300×300 dpi.” The screen 106 has a Yes button 106a and a No button 106b.

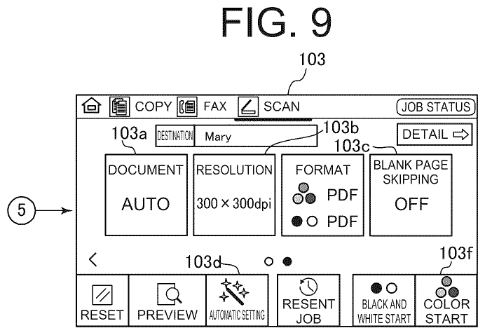

In a case where operation of pressing the Yes button 106a is performed on the touch panel display 31, the controller 26 stores the manually changed setting content “300× 300 dpi” and terminates displaying of the screen 106 on the touch panel display 31, as illustrated in FIG. 9.

1. 5 Process Flow in Case where Image Reader Reads Image

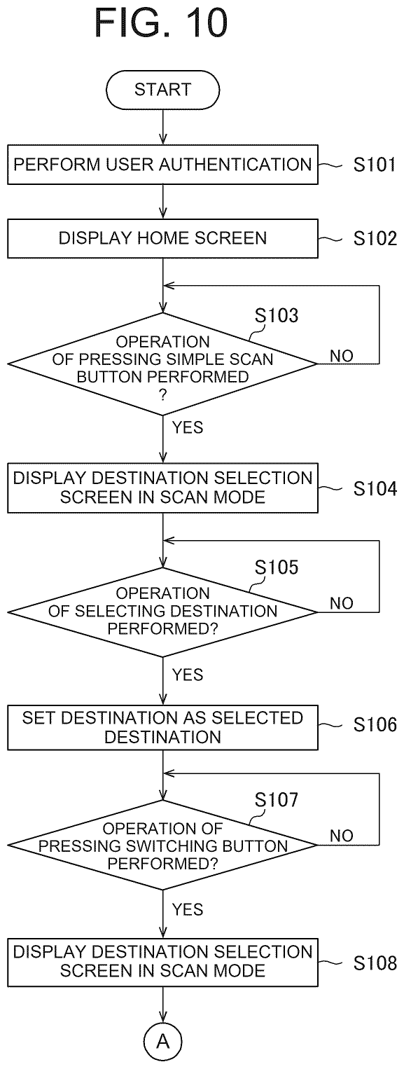

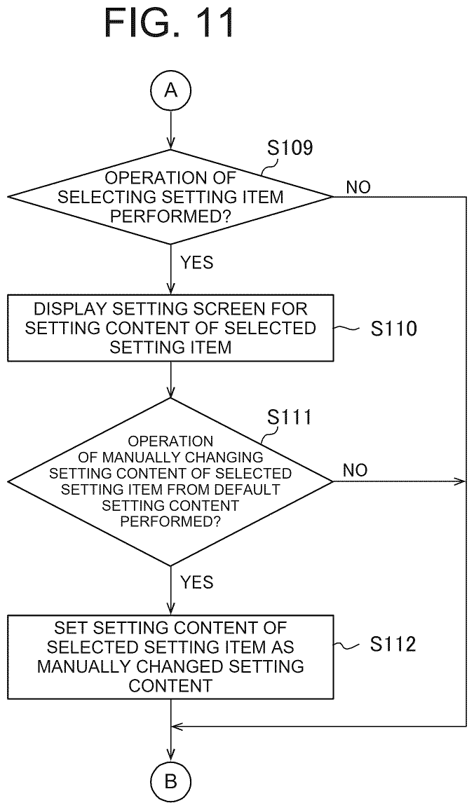

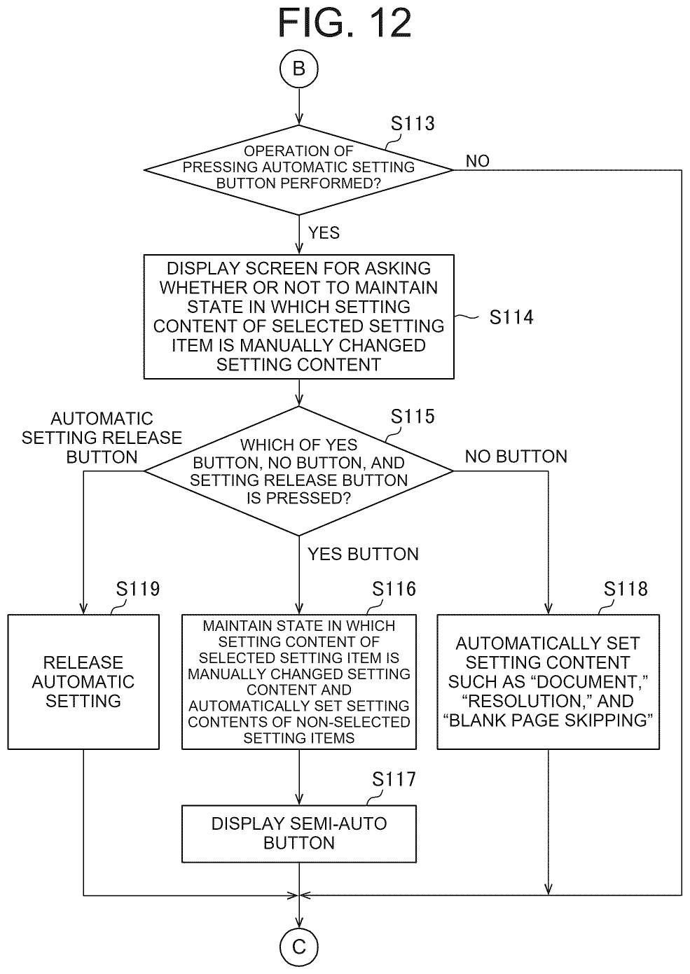

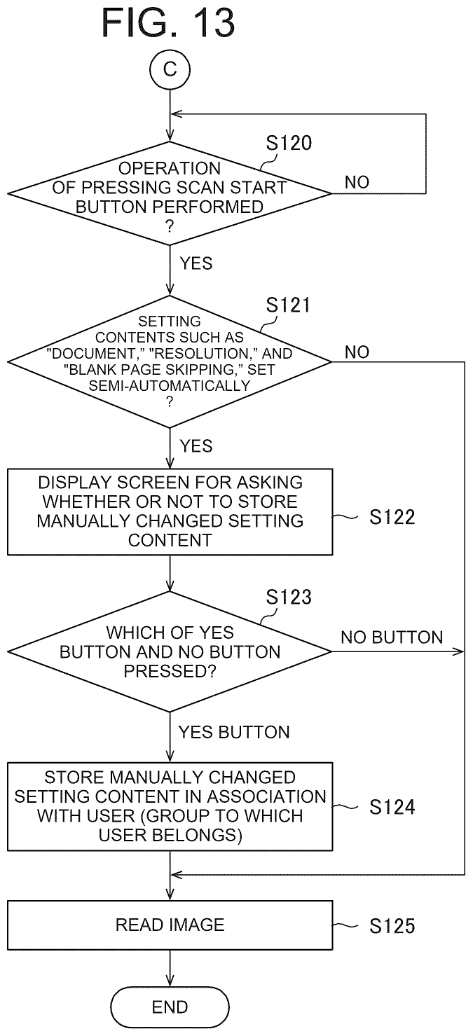

FIG. 10 to FIG. 13 are flowcharts each illustrating an example of a flow of processes performed by the controller in a case where the controller provided in the MPF of the first embodiment causes the image reader provided in the MPF to read an image.

In a case where the controller 26 causes the image reader 21 to read an image, the controller 26 executes Steps S101 to S125 illustrated in FIG. 10 to FIG. 13.

In Step S101, the controller 26 performs user authentication. Consequently, the controller 26 identifies the user who uses the MPF 1. The controller 26 performs the user authentication on the basis of a user number entered by the operation performed on the operation acceptor 24. Alternatively, the controller 26 performs the user authentication on the basis of a login name and a password entered by the operation performed on the operation acceptor 24. Or, in a case where the MPF 1 includes an integrated circuit (IC) card reader, the controller 26 performs the user authentication on the basis of data read from an IC card by the IC card reader. The administrator of the MPF 1 can perform setting of a functional content of the MPF 1 and can perform setting of automatic setting for each user.

In the following Step S102, the controller 26 causes the touch panel display 31 to display the home screen 101.

In the following Step S103, the controller 26 determines whether or not operation of pressing the simple scan button 101a is performed on the touch panel display 31. In a case where the controller 26 determines that the operation is performed on the touch panel display 31, the controller 26 executes Step S104. In a case where the controller 26 determines that the operation is not performed on the touch panel display 31, the controller 26 executes Step S103 again.

In Step S104, the controller 26 terminates displaying of the home screen 101 on the touch panel display 31, and causes the touch panel display 31 to display the destination selection screen 102 in the scan mode.

In Steps S103 and S104, the controller 26 waits until the simple scan button 101a is pressed, and in response to the pressing of the simple scan button 101a, the controller 26 switches a screen to be displayed on the touch panel display 31 from the home screen 101 to the destination selection screen 102 in the scan mode.

In the following Step S105, the controller 26 determines whether or not operation of selecting a destination is performed on the touch panel display 31. In a case where the controller 26 determines that the operation is performed on the touch panel display 31, the controller 26 executes Step S106. In a case where the controller 26 determines that the operation is not performed on the touch panel display 31, the controller 26 executes Step S105 again.

In Step S106, the controller 26 sets the destination as the selected destination.

In Steps S105 and S106, the controller 26 waits until the destination is selected, and in response to the selection of the destination, the controller 26 sets the destination as the selected destination.

In Step S107, the controller 26 determines whether or not operation of pressing the switching button 102a is performed on the touch panel display 31. In a case where the controller 26 determines that the operation is performed on the touch panel display 31, the controller 26 executes Step S108. In a case where the controller 26 determines that the operation is not performed on the touch panel display 31, the controller 26 executes Step S107 again.

In Step S108, the controller 26 terminates the displaying of the destination selection screen 102 in the scan mode on the touch panel display 31, and displays the setting screen 103 in the scan mode on the touch panel display 31.

In Steps S107 and S108, the controller 26 waits until the switching button 102a is pressed, and in response to the pressing of the switching button 102a, the controller 26 switches a screen to be displayed on the touch panel display 31 from the destination selection screen 102 in scan mode to the setting screen 103 in scan mode.

In the following Step S109, the controller 26 determines whether or not operation of selecting a setting item is performed on the touch panel display 31. In a case where the controller 26 determines that the operation is performed on the touch panel display 31, the controller 26 executes Step S110. In a case where the controller 26 determines that the operation is not performed on the touch panel display 31, the controller 26 executes Step S113.

In Step S110, the controller 26 causes the touch panel display 31 to display a setting screen for the setting content of the selected setting item, which is superimposed on the setting screen 103 in the scan mode.

In Steps S109 and S110, in a case where the document button 103a is pressed and the “document” is selected, the controller 26 causes the touch panel display 31 to display the document setting screen superimposed on the setting screen 103 in the scan mode. Furthermore, in a case where the resolution button 103b is pressed and the “resolution” is selected, the controller 26 causes the touch panel display 31 to display the resolution setting screen 104 superimposed on the setting screen 103 in the scan mode. Furthermore, in a case where the blank page skipping button 103c is pressed and the “blank page skipping” is selected, the controller 26 causes the touch panel display 31 to display the blank page skipping setting screen superimposed on the setting screen 103 in the scan mode.

In Step S111, the controller 26 determines whether or not operation of manually setting the setting content of the selected setting item is performed on the touch panel display 31. The operation is operation of changing the setting content of the selected setting item from the default setting content of the selected setting item. In a case where the controller 26 determines that the operation is performed on the touch panel display 31, the controller 26 executes Step S112. In a case where the controller 26 determines that the operation is not performed on the touch panel display 31, the controller 26 executes Step S113.

In Step S112, the controller 26 sets the setting content of the selected setting item as the manually changed setting content. For example, in a case where a series of operation consisting of the pressing of the resolution button 103b, the selecting of the manually changed setting content “300×300 dpi,” and the pressing of the OK button 104a is performed on the touch panel display 31, the controller 26 sets the setting content of the “resolution” to the manually changed setting content “300×300 dpi.”

The series of the operation consisting of the pressing of the resolution button 103b, the selecting of the manually changed setting content “300×300 dpi,” and the pressing of the OK button 104a is an example of the first operation 61. The setting content of the selected setting item is an example of the setting content of at least the one setting item that is manually changed. The setting contents of the setting items which are not selected are examples of the setting contents of the remaining setting items.

In Steps S111 and S112, in a case where operation of selecting the setting item and operation of manually changing the setting content of the selected setting item from the default setting content are performed on the touch panel display 31, the controller 26 sets the setting content of the selected setting item as the manually changed setting content. Furthermore, in a case where the operation is not performed on the touch panel display 31, the controller 26 maintains the setting content of the selected setting item as the default setting content of the selected setting item.

In the following Step S113, the controller 26 determines whether or not the operation of pressing the automatic setting button 103d is performed on the touch panel display 31. In a case where the controller 26 determines that the operation is performed on the touch panel display 31, the controller 26 executes Step S114. In a case where the controller 26 determines that the operation is not performed on the touch panel display 31, the controller 26 executes Step S120.

In Step S114, the controller 26 causes the touch panel display 31 to display the screen 105 superimposed on the setting screen 103 in the scan mode. The screen 105 asks whether or not to maintain the state in which the setting content of the selected setting item is the manually changed setting content. For example, the screen 105 asks whether or not to maintain the state in which the setting content of the “resolution” is the manually changed setting content “300×300 dpi.”

In the following Step S115, the controller 26 determines which of the Yes button 105a, the No button 105b, and the automatic setting release button 105c is pressed on the touch panel display 31. In a case where the controller 26 determines that the operation of pressing the Yes button 105a is performed on the touch panel display 31, the controller 26 executes Step S116. In a case where the controller 26 determines that the operation of pressing the No button 105b is performed on the touch panel display 31, the controller 26 executes Step S118. In a case where the controller 26 determines that the operation of pressing the automatic setting release button 105c is performed on the touch panel display 31, the controller 26 executes Step S119.

In Step S116, the controller 26 maintains the state in which the setting content of the selected setting item is the manually changed setting content and automatically sets the setting contents of the non-selected setting items.

In the following Step S117, the controller 26 terminates the displaying of the automatic setting button 103d on the touch panel display 31 and displays the semi-auto button 103e on the touch panel display 31.

In Step S118, the controller 26 does not maintain the state in which the setting content of the selected setting item is the manually changed setting content, but automatically sets the setting content of the “document,” the “resolution,” the “blank page skipping,” and the like.

In Step S119, the controller 26 releases the automatic setting. That is, the controller 26 maintains the state in which the setting content of the selected setting item is the manually changed setting content, and sets the setting content of the setting item which is not selected as the default setting content of the setting item which is not selected.

In Step S120 following Steps S117, S118, and S119, the controller 26 determines whether or not operation of pressing the scan start button 103f is performed on the touch panel display 31. In a case where the controller 26 determines that the operation is performed on the touch panel display 31, the controller 26 executes Step S121. In a case where the controller 26 determines that the operation is not performed on the touch panel display 31, the controller 26 executes Step S120 again.

In Step S121, the controller 26 determines whether or not the setting content of the selected setting item is the manually changed setting content and whether or not the setting contents of the setting items which are not selected is automatically set, that is, whether or not the setting contents of the “document,” the “resolution,” the “blank page skipping,” and the like are set semi-automatically. In a case where the controller 26 determines that the setting contents of “document,” “resolution,” “blank page skipping,” and the like are set semi-automatically, the controller 26 executes Step S122. In a case where the controller 26 determines that the setting contents of the “document,” the “resolution,” the “blank page skipping,” and the like are not set semi-automatically, the controller 26 executes Step S125.

In Step S122, the controller 26 causes the touch panel display 31 to display the screen 106 superimposed on the setting screen 103 in the scan mode. The screen 106 asks whether or not to store the manually changed setting content.

In the following Step S123, the controller 26 determines which of the Yes button 106a and the No button 106b is pressed on the touch panel display 31. In a case where the controller 26 determines that the operation of pressing the Yes button 106a is performed on the touch panel display 31, the controller 26 executes Step S124. In a case where the controller 26 determines that the operation of pressing the No button 106b is performed on the touch panel display 31, the controller 26 executes Step S125.

In the following Step S124, the controller 26 stores the manually changed setting content in association with the user. In addition, the controller 26 sets the default setting content of the selected setting item to the stored setting content. The stored setting content is recalled in a case where the automatic setting button 103d is pressed again. The associated user is the user in storing the manually changed setting content, that is, the user identified in Step S101.

In the following Step S125, the controller 26 causes the image reader 21 to read the image in accordance with the setting contents of the “document,” the “resolution,” the “blank page skipping,” and the like.

In Steps S120 to S125, the controller 26 waits until the scan start button 103f is pressed. In addition, in a case where the controller 26 semi-automatically sets the setting contents of the “document,” the “resolution,” “blank page skipping,” and the like, the controller 26 asks whether or not to store the manually changed setting content in response to the pressing of the scan start button 103f. When storing of the manually changed setting content is instructed, the controller 26 stores the manually changed setting content. Next, the controller 26 causes the image reader 21 to read the image. On the other hand, in a case where the controller 26 does not set the setting contents of the “document,” the “resolution,” the “blank page skipping,” and the like semi-automatically, the controller 26 causes the image reader 21 to immediately read the image in response to the pressing of the scan start button 103f.

Steps S122 and S123 may be omitted, and in a case where the setting contents of the “document,” the “resolution,” the “blank page skipping,” and the like are set semi-automatically, Steps S124 and S125 may be immediately executed in response to the pressing of the scan start button 103f.

1. 6 Example of Process Flow in Case where Image Reader Reads Image after Manually Changed Setting Content is Stored

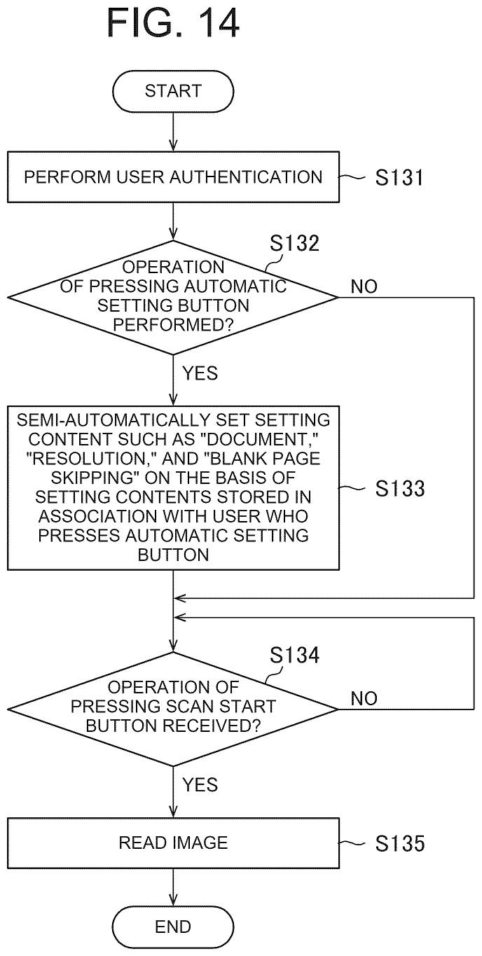

FIG. 14 is a flowchart illustrating an example of a flow of processes performed by the controller in a case where the controller provided in the MPF of the first embodiment causes the image reader provided in the MPF to read the image after the manually changed setting content is stored.

The controller 26 executes Steps S131 to S135 illustrated in FIG. 14, in a case where the controller 26 causes the image reader 21 to read the image after the manually changed setting content is stored.

In Step S131, the controller 26 performs user authentication. Consequently, the controller 26 identifies the user who uses the MPF 1. A method of the user authentication in Step S131 is the same as a method of the user authentication in Step S101.

In the following Step S132, the controller 26 determines whether or not operation of pressing the automatic setting button 103d is performed on the touch panel display 31. In a case where the controller 26 determines that the operation is performed on the touch panel display 31, the controller 26 executes Step S133. In a case where the controller 26 determines that the operation is not performed on the touch panel display 31, the controller 26 executes Step S134.

In Step S133, the controller 26 reads out the setting contents stored in association with the user in pressing of the automatic setting button 103d on the touch panel display 31, and semi-automatically sets the setting contents of the “document,” the “resolution,” the “blank page skipping,” and the like on the basis of the read-out setting contents. The controller 26 sets, as the setting content stored in association with the user, the setting content of the setting item selected when the manually changed setting content is stored, and automatically sets the setting contents of the setting items that are not selected when the manually changed setting content is stored.

In Steps S132 and S133, in a case where the automatic setting button 103d is pressed after the manually changed setting content is stored, the controller 26 recalls the manually changed setting content and semi-automatically sets the setting contents of the “document,” the “resolution,” the “blank page skipping,” and the like.

In Step S134, the controller 26 determines whether or not the operation of pressing the scan start button 103f is performed on the touch panel display 31. In a case where the controller 26 determines that the operation is performed on the touch panel display 31, the controller 26 executes Step S135. In a case where the controller 26 determines that the operation is not performed on the touch panel display 31, the controller 26 executes Step S134 again.

In Step S135, the controller 26 causes the image reader 21 to read the image in accordance with the setting contents of the “document,” the “resolution,” the “blank page skipping,” and the like.

In Steps S134 and S135, the controller 26 waits until the scan start button 103f is pressed, and in response to the pressing of the scan start button 103f, the controller 26 causes the image reader 21 to read the image.

### 1. 7 Modification

In the first embodiment, in Step S124, the controller 26 stores the manually changed setting content in association with the user, and in Step S133, the controller 26 sets the setting content of the selected setting item as the setting content stored in association with the user.

On the other hand, in a modification of the first embodiment, in Step S124, a controller 26 stores a manually changed setting content in association with a group to which a user belongs, and in Step S133, a setting content of a selected setting item is set as a setting content stored in association with the group to which the user belongs. An administrator of an MPF 1 can set a functional content of the MPF 1 and creates a group, and can set automatic setting for each group.

### 2 Second Embodiment

In the following, differences between a second embodiment and the first embodiment will be described. For points not described, the same configurations as that adopted in the first embodiment are also adopted in the second embodiment.

2. 1 Screen Transition in Case where Manual Change Setting Item in Semi-Auto Mode is Registered

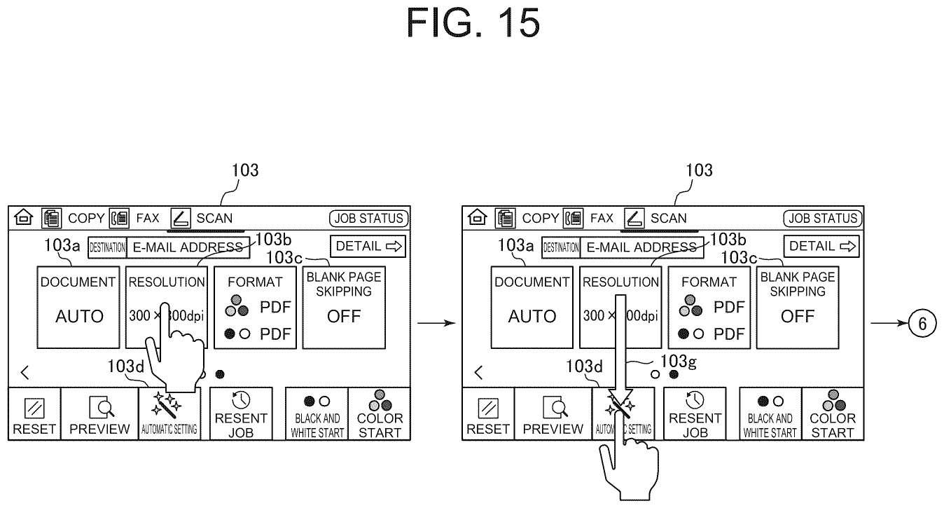

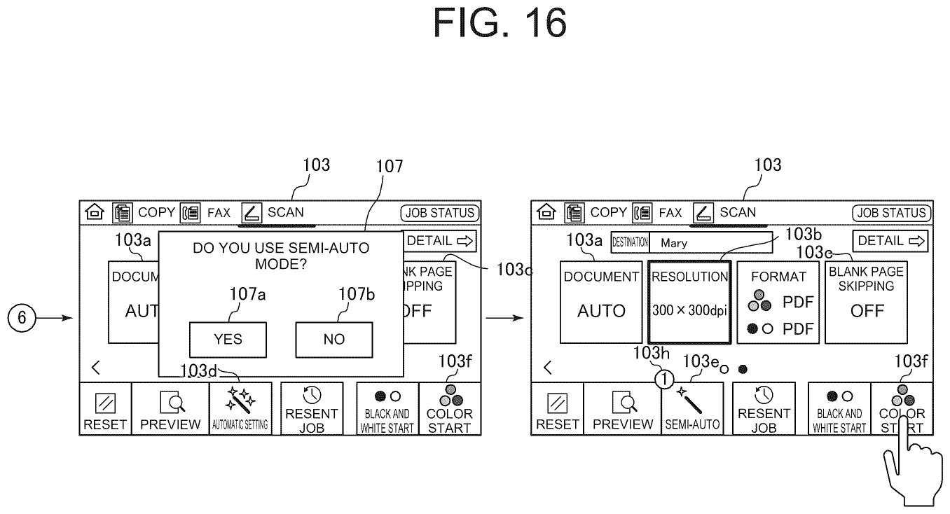

FIG. 15 and FIG. 16 are diagrams each illustrating an example of screen transition which a controller in a MPF of the second embodiment causes a touch panel display provided in the MPF to display in a case where the controller registers a manual change setting item in a semi-auto mode.

In a case where the manual change setting item in the semi-auto mode is registered, a controller 26 performs transition of a screen to be displayed on a touch panel display 31 as illustrated in FIG. 4 to FIG. 6, and then performs transition as illustrated in FIG. 15 and FIG. 16.

In a case where operation of pressing and holding a resolution button 103b is performed on the touch panel display 31 as illustrated on the left side of FIG. 15, the controller 26 causes the touch panel display 31 to display an arrow 103g as illustrated on the right side of FIG. 15. The arrow 103g moves to prompt dragging of the resolution button 103b onto an automatic setting button 103d. The controller 26 may cause the touch panel display 31 to display a figure other than the arrow 103g. For example, the controller 26 may cause the touch panel display 31 to display a hand-shaped figure.

In a case where the operation of dragging the resolution button 103b onto the automatic setting button 103d is performed on the touch panel display 31 as illustrated on the right side of FIG. 15, the controller 26 causes the touch panel display 31 to display a screen 107 superimposed on the setting screen 103 in the scan mode, as illustrated on the left side of FIG. 16. The screen 107 asks whether or not to set setting contents of “document,” “resolution,” “blank page skipping,” and the like semi-automatically. The screen 107 has a Yes button 107a and a No button 107b.

The controller 26 registers the “resolution” as a manual change setting item in the semi-automatic mode in a case where a Yes button 107a is pressed on the touch panel display 31. In addition, the controller 26 maintains a state in which a setting content of “resolution” is resolution “300×300 dpi,” and automatically sets setting contents of the “document,” the “blank page skipping,” and the like. That is, the controller 26 semi-automatically sets the setting contents of the “document,” the “resolution,” the “blank page skipping,” and the like. The controller 26 also updates a setting screen 103 in the scan mode, as illustrated on the right side of FIG. 16. At that time, the controller 26 causes the touch panel display 31 to display a semi-auto button 103e and a badge 103h instead of the automatic setting button 103d. The semi-auto button 103e indicates that the state in which the setting content of the “resolution” is the manually changed setting content “300× 300 dpi” is maintained and that the setting contents of the “document,” the “blank page skipping,” and the like are automatically set. The badge 103h indicates the number of the setting items registered as the manual change setting items. The badge 103h is superimposed on the semi-auto button 103e to be displayed, or is displayed along the semi-auto button 103e. In addition, the controller 26 changes the display state of the resolution button 103b from a normal display state to a display state indicating that the “resolution” is registered as the manual change setting item. The change from the normal display state to the display state indicating the registration as the manual change setting item is made by, for example, changing brightness, color, shape, and the like.

The setting content of the setting item registered as the manual change setting item is an example of the setting content of at least one setting item that is manually changed. The setting content of a setting item that is registered as the manual change setting item is an example of the setting contents of the remaining setting items.

Dragging of the resolution button 103b onto the automatic setting button 103d is an example of third operation 63. The controller 26 causes the touch panel display 31 to display a first operation target such as the resolution button 103b and a second operation target such as the automatic setting button 103d, and in a case where operation of dragging the first operation target onto the second operation target is performed on the touch panel display 31, the setting contents of the “document,” the “resolution,” the “blank page skipping,” and the like are semi-automatically set, so that the user can intuitively select a setting item to be registered as the manual change setting item.

The controller 26 causes the touch panel display 31 to display a third operation target such as the semi-auto button 103e, which is different from the second operation target such as the automatic setting button 103d, so that the user can easily recognize that the setting contents of the “document,” the “resolution,” the “blank page skipping,” and the like are set semi-automatically.

The controller 26 causes the touch panel display 31 to display a fourth operation target indicating the number of the setting items registered as the manual change setting items such as the badge 103h, so that the user can easily recognize the number of the setting items registered as the manual change setting items.

2. 2 Processes in Case where Manual Change Setting Item is Registered

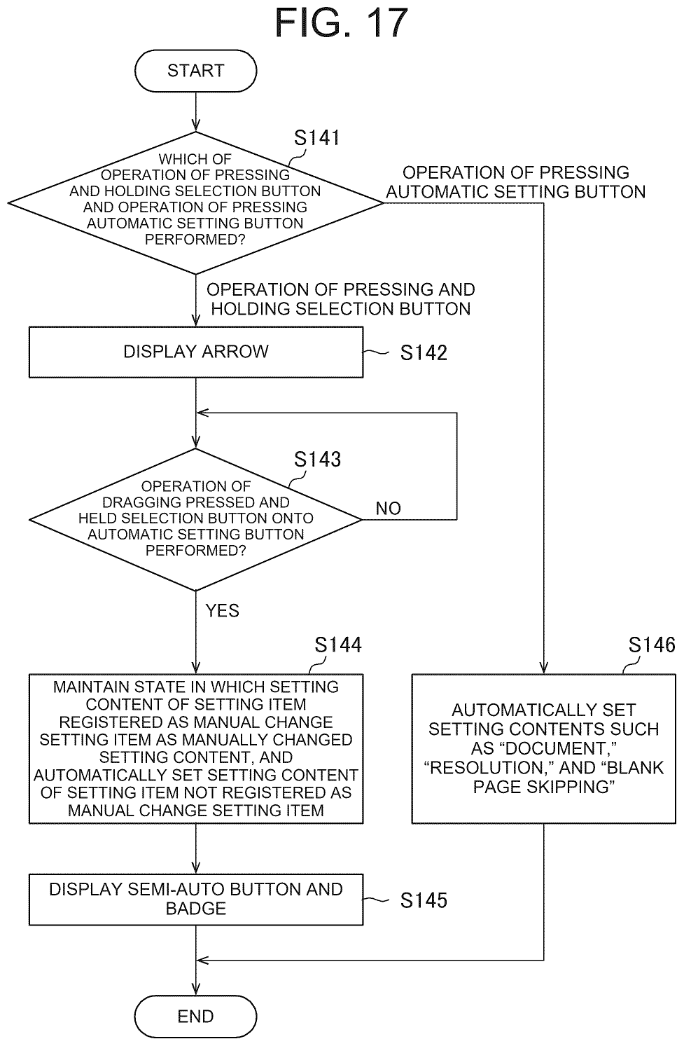

FIG. 17 is a flowchart illustrating an example of a flow of processes performed by the controller in a case where the controller provided in the MPF of the second embodiment registers the manual setting item in the semi-auto mode.

In a case where the manual change setting item in the semi-auto mode is registered, the controller 26 executes Steps S141 to S146 illustrated in FIG. 17.

In Step S141, the controller 26 determines which of operation of pressing and holding a selection button and operation of pressing the automatic setting button 103d is performed on the touch panel display 31. The selection button is a document button 103a, the resolution button 103b, or a blank page skipping button 103c. In a case where the controller 26 determines that the operation of pressing and holding the selection button is performed on the touch panel display 31, the controller 26 executes Step S142. In a case where the controller 26 determines that the operation of pressing the automatic setting button 103d is performed on the touch panel display 31, the controller 26 executes Step S146.

In the following Step S142, the controller 26 displays the arrow 103g on the touch panel display 31. The arrow 103g moves to prompt dragging of the pressed and held selection button onto the automatic setting button 103d.

In the following Step S143, the controller 26 determines whether or not operation of dragging the pressed and held selection button onto the automatic setting button 103d is performed on the touch panel display 31. In a case where the controller 26 determines that this operation is performed on the touch panel display 31, the controller 26 executes Step S144. In a case where the controller 26 does not determine that this operation is not performed on the touch panel display 31, the controller 26 executes Step S143 again.

In Step S144, the controller 26 maintains a state in which the setting content of the setting item registered as the manual change setting item is set as the manually changed setting content, and automatically sets the setting content of the setting item not registered as the manual change setting item.

In the following Step S145, the controller 26 causes the touch panel display 31 to display the semi-auto button 103e and the badge 103h.

In Steps S143 to S145, the controller 26 waits until the pressed and held selection button is dragged onto the automatic setting button 103d, and in response to the dragging of the pressed and held selection button onto the automatic setting button 103d, the controller 26 registers the setting item selected by the pressed and held selection button as the manual change setting item. The controller 26 maintains a state in which the setting content of the setting item registered as the manual change setting item is set as the manually changed setting content, and automatically sets the setting content of the setting item not registered as the manual change setting item. That is, the controller 26 semi-automatically sets the setting contents of the “document,” the “resolution,” the “blank page skipping,” and the like.

In Step S146, the controller 26 automatically sets the setting contents of the “document,” the “resolution,” the “blank page skipping,” and the like.

2. 3 Transition of Screen in Case where Manual Change Setting Item in Semi-Auto Mode is Additionally Registered

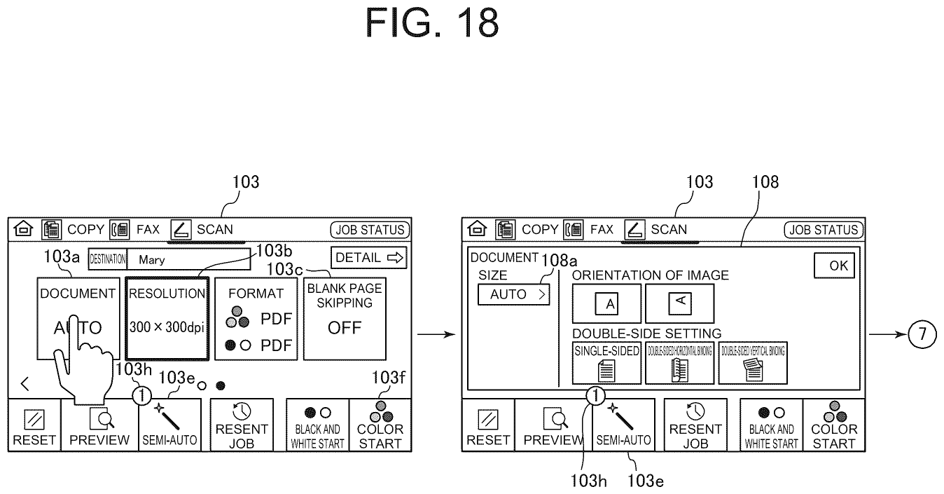

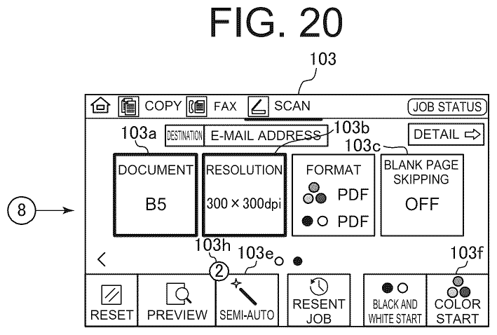

FIG. 18 to FIG. 20 are diagrams each illustrating an example of transition of a screen which the controller causes the touch panel display provided in the MPF to display in a case where the controller provided in the MPF of the second embodiment additionally registers the manual setting item in the semi-auto mode.

In a case where the manual change setting item in the semi-auto mode is additionally registered, the controller 26 performs transition of the screen displayed on the touch panel display 31 as illustrated in FIG. 18 to FIG. 20.

The controller 26 causes the touch panel display 31 to display the scan mode setting screen 103, as illustrated on the left side of FIG. 18. At this point, the setting content of the “resolution” is set to resolution “300× 300 dpi.”

As illustrated on the left side of FIG. 18, in a case where the operation of pressing the document button 103a is performed on the touch panel display 31, the controller 26 causes the touch panel display 31 to display a document setting screen 108 superimposed on the scan mode setting screen 103, as illustrated on the right side of FIG. 18. The document setting screen 108 is used to set whether to read an image on both sides or one side of a document, and to set the orientation of the image on the document. The document setting screen 108 has a call button 108a.

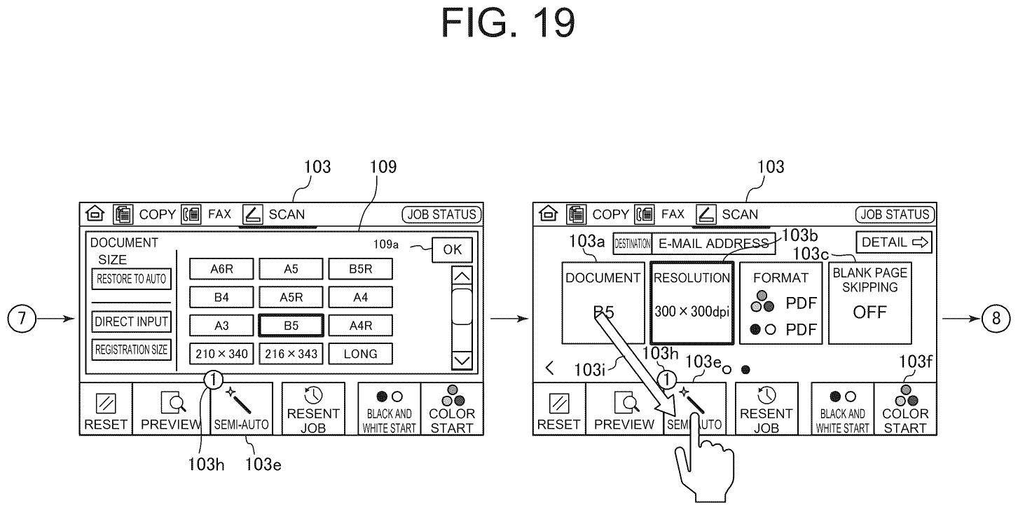

In a case where operation of pressing the call button 108a is performed on the touch panel display 31, the controller 26 terminates displaying of the document setting screen 108 on the touch panel display 31, as illustrated on the left side of FIG. 19, and causes the touch panel display 31 to display the called document setting screen 109 superimposed on the setting screen 103 in the scan mode. The document setting screen 109 is used to set the document size and the document orientation. The document setting screen 109 has an OK button 109a.

In a case where operation of selecting the setting content “B5” after the manual setting is performed on the touch panel display 31 and then operation of pressing the OK button 109a is performed on the touch panel display 31, the controller 26 terminates displaying of a document setting screen 109 on the touch panel display 31, as illustrated on the right side of FIG. 19. In addition, the controller 26 sets the setting content of the “document” to the manually set setting content “B5.” The controller 26 also updates the setting screen 103 in the scan mode. At that time, the controller 26 displays the character strings “B5” indicating the setting content “B5” after the manual setting on the document button 103a of the setting screen 103 in the scan mode.

In a case where operation of pressing and holding the document button 103a is performed on the touch panel display 31, the controller 26 causes the touch panel display 31 to display an arrow 103i, as illustrated on the right side of FIG. 19. The arrow 103i moves to prompt dragging of the document button 103a onto the automatic setting button 103d. The controller 26 may cause the touch panel display 31 to display a figure other than the document button 103a. For example, the controller 26 may cause the touch panel display 31 to display a hand-shaped figure.

As illustrated on the right side of FIG. 19, in a case where operation of dragging the document button 103a onto the automatic setting button 103d is performed on the touch panel display 31, the controller 26 maintains a state in which the setting content of the “resolution” is the manually set setting content “300×300 dpi” and the setting content of the “document” is the manually set setting content “B5,” and automatically sets the setting contents of the “blank page skipping,” and the like. That is, the controller 26 semi-automatically sets the setting contents of the “document,” the “resolution,” the “blank page skipping,” and the like. The controller 26 also updates the setting screen 103 in the scan mode. At that time, the controller 26 updates the number of setting items in the setting item indicated by the badge 103h to 2.

2. 4 Processes in Case where Manual Change Setting Item in Semi-Auto Mode is Added and Registered

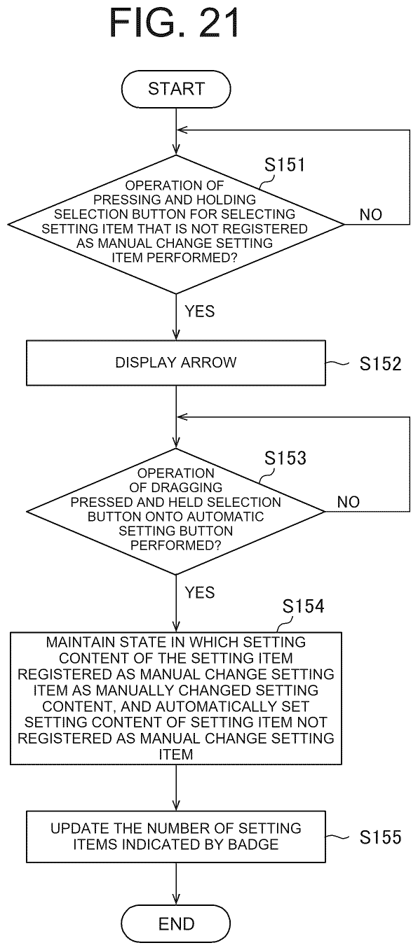

FIG. 21 a flowchart illustrating a flow of processes performed by the controller in a case where the controller provided in the MPF of the second embodiment additionally registers the manual change setting item in the semi-auto mode.

In a case where the manual change setting item in the semi-auto mode is added and registered, the controller 26 executes Steps S151 to S155 illustrated in FIG. 21.

In Step S151, the controller 26 determines whether or not operation of pressing and holding the selection button for selecting the setting item that is not registered as the manual change setting item is performed on the touch panel display 31. In a case where the controller 26 determines that the operation is performed on the touch panel display 31, the controller 26 executes Step S152. In a case where the controller 26 determines that the operation is not performed on the touch panel display 31, the controller 26 executes Step S151.

In Step S152, the controller 26 displays an arrow 103i on the touch panel display 31. The arrow 103i moves to prompt dragging of the pressed and held selection button onto the automatic setting button 103d.

In the following Step S153, the controller 26 determines whether or not operation of dragging the pressed and held selection button onto the automatic setting button 103d is performed on the touch panel display 31. In a case where the controller 26 determines that this operation is performed on the touch panel display 31, the controller 26 executes Step S154. In a case where the controller 26 determines that the operation is performed on the touch panel display 31, the controller 26 executes Step S153 again.

In Step S154, the controller 26 maintains a state in which the setting content of the setting item registered as the manual change setting item is set as the manually changed setting content, and automatically sets the setting content of the setting item not registered as the manual change setting item.

In the following Step S155, the controller 26 updates the number of setting items indicated by the badge 103h.

In Steps S151 to S155, the controller 26 waits until the selection button for selecting the setting item that is not registered as the manual change setting item is pressed and held, and in response to the selection button being pressed and held, the controller 26 display an arrow 103i on the touch panel display 31. Then, the controller 26 waits for the selection button to be dragged onto the automatic setting button 103d as prompted by the arrow 103i, and in response to the selection button being dragged onto the automatic setting button 103d as prompted by the arrow 103i, the controller 26 maintains a state in which the setting contents of the setting items that are already registered as the manual change setting items and the setting item that is additionally registered as the manual change setting item are set as the manually changed setting content, and automatically sets the setting contents of the setting items that are not registered as the manual change setting items.

2. 5 Transition of Screen in Case where Setting Content of Manual Change Setting Item in Semi-Auto Mode is Changed

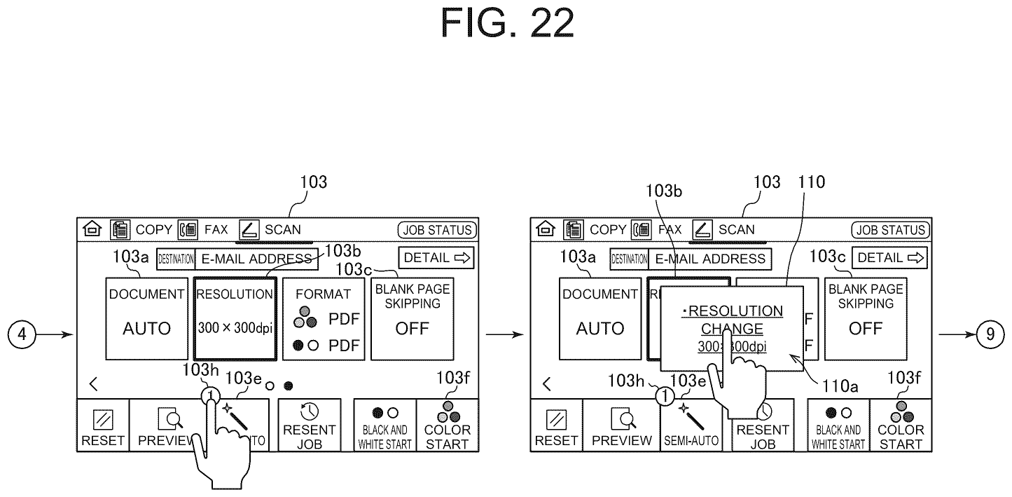

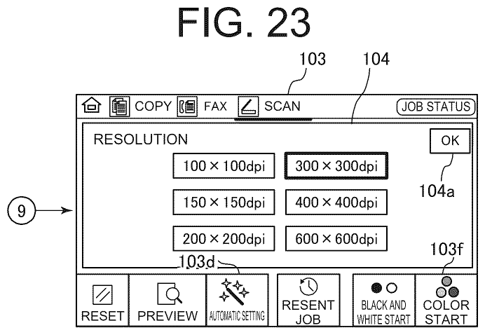

FIG. 22 and FIG. 23 are diagrams each illustrating a first example of transition of a screen which the controller causes the touch panel display provided in the MPF to display in a case where the controller provided in the MPF of the second embodiment changes the setting content of the manual change setting item in the semi-auto mode.

In a case where the setting content of the manual change setting item in the semi-auto mode is changed, the controller 26 performs transition of the screen to be displayed on the touch panel display 31 as illustrated in FIG. 22 and FIG. 23.

The controller 26 causes the touch panel display 31 to display the setting screen 103 in the scan mode, as illustrated on the left side of FIG. 22. At this time, the “resolution” is registered as the manual change setting item.

In a case where fifth operation of pressing the badge 103h is performed on the touch panel display 31 as illustrated on the left side of FIG. 22, the controller 26 causes the touch panel display 31 to display a screen 110 superimposed on the setting screen 103 in the scan mode, as illustrated on the right side of FIG. 22. The screen 110 is used to display the resolution setting screen 104. The screen 110 has a link 110a to the resolution setting screen 104.

In a case where operation of pressing the link 110a is performed on the touch panel display 31 as illustrated on the right side of FIG. 22, the controller 26 causes the touch panel display 31 to display the resolution setting screen 104 superimposed on the setting screen 103 in the scan mode, as illustrated in FIG. 23. The resolution setting screen 104 is used to change the setting content of the “resolution.”

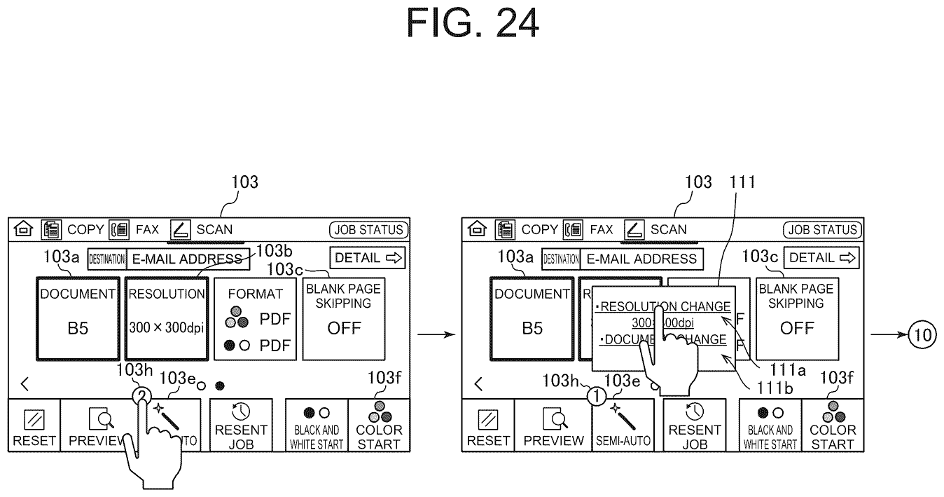

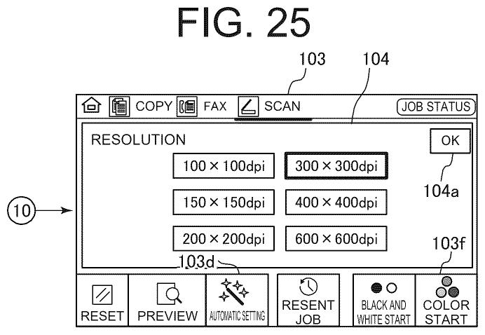

FIG. 24 and FIG. 25 are diagrams each illustrating a second example of transition of a screen which the controller causes the touch panel display provided in the MPF to display in a case where the controller provided in the MPF of the second embodiment changes the setting content of the manual setting item in the semi-auto mode.

In a case where the setting content of the manual change setting item is changed, the controller 26 performs transition of the screen to be displayed on the touch panel display 31 as illustrated in FIG. 24 and FIG. 25.

The controller 26 causes the touch panel display 31 to display the setting screen 103 in the scan mode, as illustrated on the left side of FIG. 24. At this time, the “document” and the “resolution” are registered as the manual change setting items.

In a case where the fifth operation of pressing the badge 103h is performed on the touch panel display 31 as illustrated on the left side of FIG. 24, the controller 26 causes the touch panel display 31 to display a screen 111 superimposed on the setting screen 103 in the scan mode, as illustrated on the right side of FIG. 24. The screen 111 is used to display the resolution setting screen 104 or the document setting screen 108. The screen 111 has a link 111a to the resolution setting screen 104 and a link 111b to the document setting screen 108.

In a case where operation of pressing the link 111a is performed on the touch panel display 31 as illustrated on the right side of FIG. 24, the controller 26 causes the touch panel display 31 to display the resolution setting screen 104 superimposed on the setting screen 103 in the scan mode, as illustrated in FIG. 25. The resolution setting screen 104 is used to change the setting content of the “resolution.”

2. 6 Processes in Case where Setting Content of Manual Change Setting Item is Changed

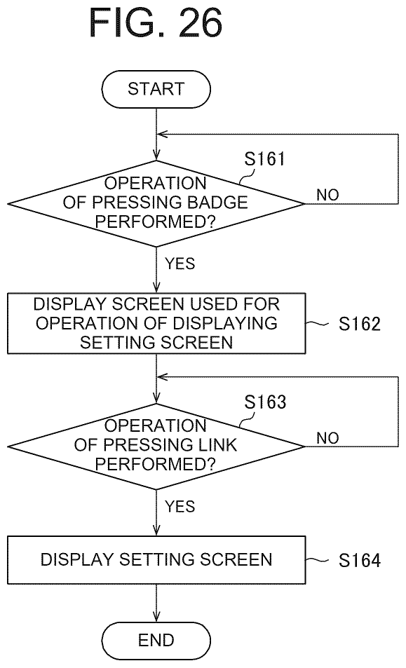

FIG. 26 is a flowchart illustrating an example of a flow of processes performed by the controller in a case where the controller provided in the MPF of the second embodiment changes the setting content of the manual setting item in the semi-auto mode.

In a case where the setting content of the manual change setting item in the semi-auto mode is changed, the controller 26 executes Steps S161 to S164 illustrated in FIG. 26.

In Step S161, the controller 26 determines whether or not operation of pressing the badge 103h is performed on the touch panel display 31. In a case where the controller 26 determines that the operation is performed on the touch panel display 31, the controller 26 executes Step S162. In a case where the controller 26 determines that the operation is not performed on the touch panel display 31, the controller 26 executes Step S161 again.

In Step S162, the controller 26 causes the touch panel display 31 to display a screen used for operation of displaying a setting screen.

In Step S163, the controller 26 determines whether or not operation of pressing the link of the displayed setting screen is performed on the touch panel display 31. In a case where the controller 26 determines that the operation is performed on the touch panel display 31, the controller 26 executes Step S164. In a case where the controller 26 determines that the operation is not performed on the touch panel display 31, the controller 26 executes Step S163 again.

In Step S164, the controller 26 causes the touch panel display 31 to display a setting screen corresponding to the pressed link.

In Steps S161 to S164, the controller 26 waits until the badge 103h is pressed, and in response to the pressing of the badge 103h, the controller 26 causes the touch panel display 31 to display a screen used for operation of displaying a setting screen. Then, the controller 26 waits for the link of the screen to be pressed, and in response to the pressing of the link of the screen, the controller 26 causes the touch panel display 31 to display the setting screen.

2. 7 Processes in Case where Semi-Auto Button is Pressed

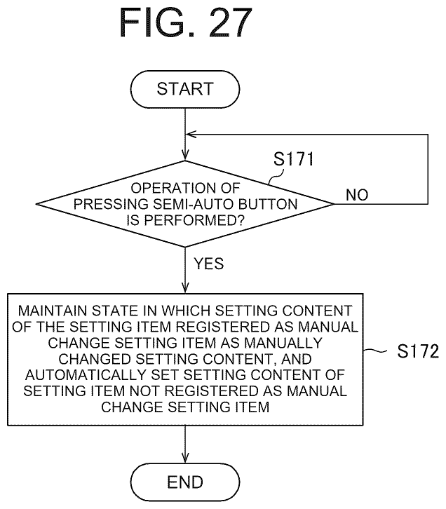

FIG. 27 is a flowchart illustrating an example of a flow of processes performed by the controller provided in the MPF in a case where the semi-auto button is pressed on the touch panel display provided in the MPF of the second embodiment.

In a case where the semi-auto button 103e is pressed, the controller 26 executes Steps S171 and S172 illustrated in FIG. 27.

In Step S171, the controller 26 determines whether or not the fourth operation of pressing the semi-auto button 103e is performed on the touch panel display 31. In a case where the controller 26 determines that the fourth operation is performed, the controller 26 executes Step S172. In a case where the controller 26 determines that the fourth operation is not performed, the controller 26 executes Step S171 again.

In Step S173, the controller 26 maintains the setting content of the setting item registered as the manual change setting item is set as the manually changed setting content, and automatically sets the setting content of the setting item not registered as the manual change setting item.

Consequently, after the setting item is registered in the semi-auto button 103e as the manual change setting item, the setting content of the registered setting item can be set as the manually changed setting content and the setting content of a setting item not registered can be automatically set to the MPF 1 simply by pressing the semi-auto button 103e.

The present disclosure is not limited to the above-described embodiments, and may be replaced with a configuration that is substantially the same as the configuration described in the above-described embodiments, a configuration that has the same function and effect, or a configuration that can achieve the same purpose.

Moreover, each functional block or various features of the apparatus used in the embodiments described above may be implemented in or executed by an electrical circuit such an integrated circuit or a plurality of integrated circuits. The electric circuit designed to execute the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may be a microprocessor or a conventional processor, a controller, a microcontroller, or a state machine. The above-described electric circuit may be configured by a digital circuit or by an analog circuit. Moreover, when a technology for forming an integrated circuit which could substitute for the current integrated circuits emerges as a result of the progress of the semiconductor technology, it is possible to use a new integrated circuit based on such technology for one or more aspects of the present disclosure.

What is claimed is:

1. An image reading device comprising:
an image reader that reads an image in accordance with setting contents of a plurality of setting items;
an operation acceptor;
a display; and
a controller, wherein
in a case where first operation of manually changing a setting content of at least one setting item included in the setting contents of the plurality of setting items is performed on the operation acceptor, the controller sets the setting content of at least the one setting item as a manually changed setting content,
in a case where third operation for an operation target, for which second operation of instructing automatic setting of the setting contents of the plurality of setting items is to be performed after the setting of the setting content of at least the one setting item as the manually changed setting content, is performed on the operation acceptor, the controller causes the display to display a screen for asking whether or not a state in which the setting content of at least the one setting item is set as the manually changed setting content is maintained, and
in a case where fourth operation of instructing maintenance of the state in which the setting content of at least the one setting item is set as the manually changed setting content is performed on the operation acceptor, the controller maintains the state in which the setting content of at least the one setting item is set as the manually changed setting content, and automatically sets setting contents of remaining setting items other than the setting content of at least the one setting item, included in the setting contents of the plurality of setting items.

2. The image reading device according to claim 1, wherein
the operation target is a button, and
the second operation and the third operation are operation of pressing the button.

3. The image reading device according to claim 1, wherein
in a case where the state in which the setting content of at least the one setting item is set as the manually changed setting content is maintained, and the setting contents of the remaining setting items are automatically set, the controller causes the display to display a screen element indicating that the state in which the setting content of at least the one setting item is set as the manually changed setting content is maintained, and the setting contents of the remaining setting items are automatically set.

4. The image reading device according to claim 1, wherein
in a case where the state in which the setting content of at least the one setting item is set as the manually changed setting content is maintained, and the setting contents of the remaining setting items are automatically set, the controller stores the manually changed setting content, and
in a case where the second operation is performed on the operation acceptor after the manually changed setting content is stored, the controller sets the setting content of at least the one setting item as a stored setting content, and automatically sets the setting contents of the remaining setting items.

5. The image reading device according to claim 4, wherein
the controller stores the manually changed setting content in association with a user in storing the manually changed setting content, and
the controller sets the setting content of at least the one setting item as a setting content stored in association with a user in performing the second operation on the operation acceptor.

6. The image reading device according to claim 4, wherein
the controller stores the manually changed setting content in association with a group to which a user in storing the manually changed setting content belongs, and
the controller sets the setting content of at least the one setting item as a setting content stored in association with a group to which a user in performing the second operation on the operation acceptor belongs.

7. The image reading device according to claim 1, wherein
the operation acceptor includes a touch panel display,
the controller causes the touch panel display to display a first operation target for which the first operation is to be performed,
the operation target is a second operation target,
the controller causes the touch panel display to display the second operation target,
the second operation is operation of pressing the second operation target, and
the third operation is operation of dragging the first operation target on the second operation target.

8. The image reading device according to claim 7, wherein
in a case where the third operation is performed on the operation acceptor, the controller causes the touch panel display to display the third operation target different from the second operation target.

9. The image reading device according to claim 8, wherein
in a case where fourth operation is performed on the third operation target, the controller sets the setting content of at least the one setting item as the manually changed setting content, and automatically sets the setting contents of the remaining setting items.

10. The image reading device according to claim 8, wherein
the controller causes the touch panel display to display a fourth operation target indicating the number of the setting item of at least the one setting item, and
in a case where fifth operation is performed on the fourth operation target, the controller causes the touch panel display to display a screen used for operation of manually changing the setting content of at least the one setting item.

11. The image reading device according to claim 1, wherein
at least the one setting item is two or more setting items.
